(19) United States
(12) Patent Application Publication
(10) Pub. No.: US 2024/0409758 A1
(43) Pub. Date: Dec. 12, 2024

(54) A METHOD OF DISPERSING A SELF-EMULSIFYING CROSSLINKER, THE OBTAINED CROSSLINKER DISPERSION AND ITS APPLICATON IN E-COAT HAVING LOW BAKING TEMPERATURE

(71) Applicant: BASF COATINGS GMBH, Muenster (DE)

(72) Inventors: Pattarasai TANGVIJITSAKUL, Shanghai (CN); Tai Jie YUE, Shanghai (CN); Tong Yuan ZHANG, Shanghai (CN); Su Jie XING, Shanghai (CN); Lin WANG, Muenster (DE)

(21) Appl. No.: 18/697,545

(22) PCT Filed: Oct. 18, 2022
(86) PCT No.: PCT/EP22/78910

§ 371 Date: Apr. 1, 2024

(30) Foreign Application Priority Data
Nov. 4, 2021 (WO) PCT/CN2021/128758

(51) Int. Cl. C09D 5/44; C08G 18/08; C08G 18/50; C08G 18/80; C09D 5/02; C09D 175/12

(52) U.S. Cl. CPC C09D 5/4465; C08G 18/0866; C08G 18/5024; C08G 18/8064; C08G 18/8077; C08G 18/808; C08G 18/8096; C09D 5/022; C09D 5/4476; C09D 175/12

(57) ABSTRACT

Disclosed herein is a method of dispersing a self-emulsifying crosslinker including at least two steps: i) preparing an aqueous acid dispersion (I) of a self-emulsifying crosslinker, and the microstructure of liquid phase of the aqueous acid dispersion (I) is water-in-oil; and ii) adding water into the aqueous acid dispersion (I) to obtain an aqueous acid dispersion (II), and the microstructure of liquid phase of the aqueous acid dispersion (II) is oil-in-water. Additionally disclosed here is a self-emulsifying crosslinker dispersion prepared by the method and the self-emulsifying crosslinker dispersion has a Z-average particle size in a range of from 50 to 200 nm.

### TECHNICAL FIELD

This invention relates to a method of dispersing a self-emulsifying crosslinker that is used in low temperature baking e-coat composition especially e-coat for automotive industry.

### BACKGROUND

In automotive industry, the curing temperature of e-coat is normally above 160° C. However, for the purpose of energy and cost saving, a trend of low temperature baking appears in e-coat, i.e. a curing temperature of from 80° C. to 140° C. is desired by OEM (Original equipment manufacturer) and ASM (automotive supply metal) markets.

To achieve the low temperature baking e-coat, the current practice is—crosslinkers (e.g. blocked isocyanate) are encapsulated by base resins (e.g. polyetheramine) and emulsified in the mixture of water and acid to obtain micelles of e-coat binder. However, through such method, the resultant binder used for e-coat is not stable in storage period. Crosslinkers and base resins are prone to react with each other in micelles. Thus, one solution is to separate crosslinkers from base resins. Crosslinkers used in such solution are so-called “self-emulsifying crosslinkers”. One example of said self-emulsifying crosslinker is cationic polyurethane crosslinker (blocked isocyanate).

During e-coat application, there will be two types of micelles to be deposited on metal substrate i.e. base resin dispersion and self-emulsifying crosslinker dispersion. The particle sizes of the two dispersions should be in the same range (e.g. 60 nm to 160 nm). Otherwise, the ratio unbalance will lead to uneven crosslinking densities of e-coat films on the metal substrate and further bring defects of mechanical properties of e-coat films.

It is easy to prepare well-dispersed base resin emulsions. However, no satisfying approach is available in the prior art to get a good dispersion of self-emulsifying crosslinker. Therefore, it is still required to provide a dispersion method to obtain an emulsion of self-emulsifying crosslinker having small particles sizes and narrow particle size distribution.

### SUMMARY OF THIS INVENTION

In one aspect, this invention provides a method of dispersing a self-emulsifying crosslinker comprising at least two steps:
i). preparing an aqueous acid dispersion (I) of a self-emulsifying crosslinker, and the microstructure of liquid phase of said aqueous acid dispersion (I) is water-in-oil; and
ii). adding water into said aqueous acid dispersion (I) to obtain an aqueous acid dispersion (II), and the microstructure of liquid phase of said aqueous acid dispersion (II) is oil-in-water.

In another aspect, this invention provides a self-emulsifying crosslinker dispersion prepared by the invented method and said self-emulsifying crosslinker dispersion has a Z-average particle size of from 50 to 200 nm and preferably from 60 to 160 nm.

In another aspect, this invention provides an e-coat composition comprising at least one base resin dispersion and at least one self-emulsifying crosslinker dispersion prepared by the invented method.

In a further aspect, this invention provides a substrate coated with the e-coat layer and said e-coat layer is formed by at least one base resin dispersion and at least one self-emulsifying crosslinker dispersion prepared by the invented method.

It is surprisingly found that by using the invented method, a self-emulsifying crosslinker dispersion is obtained with small particles sizes and narrow particle size distribution.

### DETAILED DESCRIPTION OF THIS INVENTION

The present invention now will be described in detail hereinafter. It is to be understood that the present invention may be embodied in different ways and shall not be construed as limited to the embodiments set forth herein. Unless mentioned otherwise, all technical and scientific terms used herein have the same meaning as commonly understood by one of ordinary skill in the art to which the present invention belongs.

Within the context of the present application, the singular forms “a”, “an” and “the” include plural referents unless the context clearly dictates otherwise.

Within the context of the present application, the terms “comprise(s)”, “comprising” are to be interpreted in a non-limiting, open manner. That is, further components or elements may be present.

Within the context of the present application, the term “base resin” means the main component of e-coat composition that will react with crosslinker to form e-coat binder and one example of base resin is polyetheramine.

Within the context of the present application, the term “self-emulsifying crosslinker” means crosslinker that has functional groups that could be emulsified in aqueous solution and be able to react with base resins. One example of self-emulsifying crosslinker is cationic polyurethane.

Within the context of the present application, the term “the detected maximum temperature (Tₘₐₓ)” means the detected highest temperature of the dispersion solution during the process of adding solvent (e.g. a mixture of water and acid) with stirring.

Within the context of the present application, the term “container” and “vessel” are used alternatively having the same meaning.

Self-emulsifying crosslinker is one potential approach for low temperature baking e-coat. Small particle sizes and narrow particle size distribution of dispersed polyurethane crosslinker are necessary for the storage stability. This invention is to find how to fine-tune the important processing parameters in order to get small particle size with narrow particle size distribution. Furthermore, in prior art, the synthesis and dispersion of polyurethane crosslinker are carried out in different vessels, in present invention, it is possible to implement both synthesis and dispersion steps in one vessel, which reduces cost in actual production.

This invention provides a method of dispersing a self-emulsifying crosslinker comprising at least two steps:
i). preparing an aqueous acid dispersion (I) of a self-emulsifying crosslinker, and the microstructure of liquid phase of said aqueous acid dispersion (I) is water-in-oil; and
ii). adding water into said aqueous acid dispersion (I) to obtain an aqueous acid dispersion (II), and the microstructure of liquid phase of said aqueous acid dispersion (II) is oil-in-water.

According to the present invention, the dispersion effects are analysed for cationic polyurethane crosslinker and it is found that the average particle size is small (60 nm to 160 nm) and the particle size distribution is very narrow i.e. PDI (Polydispersity Index) is less than 0.2. The average particle size and the particle size distribution are within an acceptable range, which are beneficial for storage stability as well as for evenly depositing of e-coat on metal substrates. It brings great advantage to automotive OEM and ASM markets.

The dispersing method of this invention is not only applicable for cationic polyurethane crosslinker but also can be used for other crosslinker. There are mainly two significant parameters affecting particle size and particle size distribution of crosslinker's micelles i.e. the solid content of aqueous acid dispersion (I) and the detected maximum temperature (Tₘₐₓ) during dispersion in the step ii). The solid content of aqueous acid dispersion (I) should be at least 45% by weight based on the total weight of aqueous acid dispersion (I). Tₘₐₓ can be influenced by initial temperature of crosslinker and stirring speed. Preferably, Tₘₐₓ should not be higher than 40° C. and more preferably not be higher than 30° C. The key factor of this invention is the dispersion or emulsion of self-emulsifying crosslinker shall have phase inversion from w/o (water-in-oil) to o/w (oil-in-water) during dispersion process. Such phase inversion could be observed since some dough-like matters are seen.

Furthermore, instead of using two vessels to synthesize and disperse self-emulsifying crosslinkers separately, it is proved in present invention that only one vessel is needed to carry out both polyurethane crosslinker synthesis and dispersion process and small particle size of micelles and narrow particle size distribution are achieved. One vessel with both organic polyurethane crosslinker synthesis and dispersion process would bring a great advantage for saving energy and cost of production. But by using two vessels for a cationic polyurethane dispersion, it is also able to obtain small particle size and narrow particle size distribution through the invented method.

Examples of said self-emulsifying crosslinkers include cationic polyaromatic urethane, cationic polyaliphatic urethane, waterborne amino resin, cationic polyester polyurethane, cationic polyester polyurea and cationic polycarbonate polyurethane.

Selected amines are incorporated into crosslinkers to bring self-emulsifying functions and meanwhile reactive to base resins. Examples of said amines include N-methyl diethanolamine, N-butyl diethanolamine, diethanolamine, N,N-dimethylaminopropylamine, Bis-(N,N-dimethylaminopropylamine), 2-[[2-(Dimethylamino)ethyl]methylamino]ethanol, 2-(2-Aminoethoxy)ethanol, Triethanolamine, pyridine diethanolamine, Ethanolamine, diethanolamine, N,N-dimethyl ethanolamine.

The synthesis of cationic polyurethane crosslinker is known. Saimani Sundar et al. disclosed its preparation method in “Aqueous dispersions of polyurethane cationomers: a new approach for hydrophobic modification and crosslinking”, Colloid Polym Sci (2004) 283: 209-218.

Mixtures of water and acid are used to dilute the obtained cationic polyurethane crosslinker, inorganic acids as well as low molecular organic acids could be used here. Examples of inorganic acids include diluted hydrochloric acid, diluted sulfuric acid, phosphoric acid, diluted nitric acid, boric acid and perchloric acid. Examples of organic acids include formic acid, acetic acid, lactic acid, oxalic acid, glycolic acid, citric acid, malic acid, adipic acid, succinic acid, propionic acid, fumaric acid and benzoic acid. Preferably, the acid is added into water in an amount of from 0.1 wt. % to 5.0 wt. % by weight, and more preferably from 0.5 wt. % to 2.0 wt. % based on the total weight of the mixture of water and acid.

Preferably, the dispersing of said self-emulsifying crosslinker is under a stirring and the stirring speed is preferably in a range of 500 to 2000 rpm in the first step and in a range of 200 to 1500 rpm in the second step. The stirring speed in the second step of dispersion affected the Tₘₐₓ significantly. Higher stirring speed increased Tₘₐₓ of the dispersion and a high Tₘₐₓ tends to result in big particle size and broad particle size distribution.

Preferably, the initial temperature of said self-emulsifying crosslinker is less than 35° C. When the initial temperature of said self-emulsifying crosslinker is higher than room temperature e.g. 35° C., Tₘₐₓ increased obviously and a high Tₘₐₓ tends to result in big particle size and broad particle size distribution.

Preferably, the solid content of said aqueous acid dispersion (I) in step i) is from 45% to 75% and preferably from 50% to 70% by weight, based on the total weight of said aqueous acid dispersion (I). And the solid content of said aqueous acid dispersion (II) in step ii) is from 20% to 30% by weight, based on the total weight of said aqueous acid dispersion (II). The solid content of aqueous acid dispersion (I) was important. When the solid content of aqueous acid dispersion (I) was higher than 49% (e.g. 58%), the microstructure of said dispersion was water-in-oil and the viscosity of said dispersion was quite high. As a contrast, when the solid content of aqueous acid dispersion (I) was lower than 49% (e.g. 38%), the microstructure of said dispersion was oil-in-water. The two-phase inversion of the dispersion, i.e. from water-in-oil to oil-in-water in microstructure level, brings smaller Z-average particle size and narrower particle size distribution. If there was no such phase inversion, the obtained dispersions tend to have large particle sizes and broad particle size distribution.

Preferably, said self-emulsifying crosslinker dispersion has a Z-average particle size of from 50 to 200 nm and more preferably from 60 to 160 nm.

Preferably, said self-emulsifying crosslinker dispersion has a PDI (Polydispersity Index) of less than 0.2 and more preferably less than 0.1.

Although according to the present invention, it is advantageous to prepare the crosslinker dispersion in one container or vessel, the dispersion of said self-emulsifying crosslinker could be also prepared in more than one container or vessel such as two containers. And the key issue is despite how many container(s) or vessel(s) are used, the two-phase inversion of the dispersion must happen.

As a comparison, one-step dispersion approach is carried out by using two containers or vessels. The one-step dispersion approach is defined as follows: the self-emulsifying crosslinker was put in one container (the 1^{st} container) and an aqueous acid solution was prepared in another container (the 2^{nd} container) and the cationic polyurethane crosslinker in the 1^{st} container was continuously added into the 2^{nd} container with a stirring to reach certain solid content. By using two vessels and one-step dispersing approach, the obtained dispersions had large particle sizes and broad particle size distributions. The reason is in one-step dispersing approach, there was no chance for phase inversion i.e. from water-in-oil to oil-in-water, of the dispersions in microstructure level.

Moreover, the present invention also provides an e-coat composition comprising at least one base resin dispersion and at least one invented self-emulsifying crosslinker dispersion. Said base resin is preferably at least one selected from polyetheramine and polyetheramine-based epoxy resin. Said e-coat composition could be cured at a temperature of from 80° C. to 140° C. to form an e-coat layer. And such layer is formed on various substrates especially metallic substrates.

### EMBODIMENT

Various embodiments are list below. It will be understood that the embodiments listed below may be combined with all aspects and other embodiments in accordance with the scope of the invention.

### Embodiment 1

A method of dispersing a self-emulsifying crosslinker comprising at least two steps:
i). preparing an aqueous acid dispersion (I) of a self-emulsifying crosslinker, wherein the microstructure of liquid phase of said aqueous acid dispersion (I) is water-in-oil; and
ii). adding water into said aqueous acid dispersion (I) to obtain an aqueous acid dispersion (II), wherein the microstructure of liquid phase of said aqueous acid dispersion (II) is oil-in-water.

### Embodiment 2

The method of dispersing a self-emulsifying crosslinker according to Embodiment 2, wherein said self-emulsifying crosslinker is preferably at least one selected from cationic polyaromatic urethane, cationic polyaliphatic urethane, waterborne amino resin, cationic polyester polyurethane, cationic polyester polyurea and cationic polycarbonate polyurethane.

### Embodiment 3

The method of dispersing a self-emulsifying crosslinker according to any one of Embodiments 1 to 2, wherein in step i) it is preferably to prepare said aqueous acid dispersion (I) by mixing the self-emulsifying crosslinker, acid and water under stirring at a rate of from 500 to 2000 rpm and in step ii) it is preferably to prepare said aqueous acid dispersion (II) under stirring at a rate of from 200 to 1500 rpm.

### Embodiment 4

The method of dispersing a self-emulsifying crosslinker according to any one of Embodiments 1 to 3, wherein the solid content of said aqueous acid dispersion (I) in step i) is from 45% to 75% and preferably from 50% to 70% by weight, based on the total weight of said aqueous acid dispersion (I).

### Embodiment 5

The method of dispersing a self-emulsifying crosslinker according to any one of Embodiments 1 to 4, wherein the solid content of said aqueous acid dispersion (II) in step ii) is from 20% to 30% by weight, based on the total weight of said aqueous acid dispersion (II).

### Embodiment 6

The method of dispersing a self-emulsifying crosslinker according to any one of Embodiments 1 to 5, wherein the detected maximum temperature (Tₘₐₓ) of said aqueous acid dispersion (II) in step ii) is no more than 40° C. and preferably no more than 30° C.

### Embodiment 7

The method of dispersing a self-emulsifying crosslinker according to any one of Embodiments 1 to 6, wherein the acid used in step i) to prepare said aqueous acid dispersion (I) is preferably at least one selected from diluted hydrochloric acid, diluted sulfuric acid, phosphoric acid, diluted nitric acid, boric acid, perchloric acid, formic acid, acetic acid, lactic acid, oxalic acid, glycolic acid, citric acid, malic acid, adipic acid, succinic acid, propionic acid, fumaric acid and benzoic acid.

### Embodiment 8

The method of dispersing a self-emulsifying crosslinker according to any one of Embodiments 1 to 7, wherein the weight percentage of acid in said aqueous acid dispersion (I) is from 0.1 wt % to 5.0 wt. % and preferably from 0.5 wt. % to 2.0 wt. %.

### Embodiment 9

A self-emulsifying crosslinker dispersion prepared by the method according to any one of Embodiments 1 to 8, wherein said self-emulsifying crosslinker dispersion has a Z-average particle size of from 50 to 200 nm and preferably from 60 to 160 nm.

### Embodiment 10

The self-emulsifying crosslinker dispersion according to Embodiment 9, wherein said self-emulsifying crosslinker dispersion has a PDI (Polydispersity Index) of less than 0.2 and preferably less than 0.1.

### Embodiment 11

The self-emulsifying crosslinker dispersion according to any one of Embodiments 9 to 10, wherein the solid content of said self-emulsifying crosslinker dispersion is from 20% to 30% by weight.

### Embodiment 12

The self-emulsifying crosslinker dispersion according to any one of Embodiments 9 to 11, wherein said self-emulsifying crosslinker dispersion comprising at least one selected from cationic polyaromatic urethane, cationic polyaliphatic urethane, waterborne amino resin, cationic polyester polyurethane, cationic polyester polyurea and cationic polycarbonate polyurethane.

### Embodiment 13

An e-coat composition comprising at least one base resin dispersion and at least one self-emulsifying crosslinker dispersion according to any one of Embodiments 9 to 12.

### Embodiment 14

The e-coat composition according to Embodiment 13, wherein said base resin is preferably at least one selected from polyetheramine and polyetheramine-based epoxy resin.

### Embodiment 15

The e-coat composition according to any one of Embodiments 13 to 14, wherein said e-coat composition has a curing temperature of from 80° C. to 140° C.

### Embodiment 16

An e-coat layer obtained from the e-coat composition according to any one of Embodiments 13 to 15 after curing at a temperature of from 80° C. to 140° C.

### Embodiment 17

A substrate coated with the e-coat layer according to Embodiment 16.

### EXAMPLE

The present invention will be further described by Examples which are not intended to limit the scope of the present invention. And all raw materials used in Examples are commercially available.

Examples 1 to 3 describe how the cationic polyurethane crosslinker is prepared. Lupranate®M20S is an oligomeric methylene diphenyl diisocyanate (MDI) from BASF. methylethyl ketoxime (MEKO) acts as a blocking agent, methylisobutyl ketone (MIBK) acts as a solvent, dibutyltin dilaurate (DBTL) as a catalyst. N-methyl diethanolamine, N-butyl diethanolamine, diethanolamine (DEOLA), N, N-dimethylaminopropylamine (DMAPA), Bis-(N, N-dimethylaminopropylamine) (BDMAPA), 2-[[2-(Dimethylamino)ethyl]methylamino]ethanol (DMAEA), 2-(2-Aminoethoxy)ethanol (AEEOL), triethanolamine, pyridine diethanolamine, ethanolamine, diethanolamine, N,N-dimethyl ethanolamine are amines, containing a nitrogen atoms, acts as a neutralizing agent.

### Example 1: Preparation of MEKO-Blocked Lupranate®M20S by Using N, N-Dimethylaminopropylamine (DMAPA) as an Amine Building Block for Neutralization

A reactor equipped with a condenser, a nitrogen gas inlet and outlet, was charged with 400 parts by weight of Lupranate®M20S, 126.1 parts by weight of MIBK, and 0.18 parts by weight of DBTL. This initial charge was heated to 30° C. After that, 153.0 parts by weight of Bisphenol A 6EO was being dosed into a reactor in a uniform rate within 60 min with a constant stirring. 378.3 parts by weight of MIBK was then added into the reactor, parallelly cooling the reaction temperature to 30° C. At reaction temperature 30° C., 150.5 parts by weight of MEKO was slowly dosed into the reactor within 20 min. After finishing dosing MEKO, a reaction temperature was raised up to 60° C. and continued the reaction for another 30 min. Then cooling the reaction temperature to 30° C. again and begin a next step by quickly charging 53.0 parts by weight of DMAPA into the reactor. 20 min after finishing charging, set the reaction temperature to 60° C. again and continued stirring for another 30 min. A polyurethane crosslinker was obtained.

### Example 2: Preparation of MEKO-Blocked Lupranate®M20S by Using Bis-(N, N-Dimethylaminopropylamine) or (BDMAPA) as an Amine Building Block for Neutralization

500 parts by weight of Lupranate®M20S, 139.9 parts by weight of MIBK, and 0.23 parts by weight of DBTL were charged into a reactor equipped with a condenser, a nitrogen gas inlet and outlet. This initial charge was heated to 30° C. After that, 30.7 parts by weight of 1,2-propanediol (PD) was being dosed into a reactor in a uniform rate within 60 min with a constant stirring. 419.7 parts by weight of MIBK was then added into the reactor, parallelly cooling the reaction temperature to 30° C. At reaction temperature 30° C., 187.5 parts by weight of MEKO was slowly dosed into the reactor within 20 min. After finishing dosing MEKO, a reaction temperature was raised up to 60° C. and continued the reaction for another 30 min. Then cooling the reaction temperature to 30° C. again and begin a next step by quickly charging 120.9 parts by weight of BDMAPA into the reactor. 20 min after finishing charging, set the reaction temperature to 60° C. again and continued stirring for another 30 min. A polyurethane crosslinker was obtained.

### Example 3: Preparation of MEKO-blocked Lupranate®M20S by Using 2-[[2-(Dimethylamino)ethyl]methylamino]ethanol (DMAEA) as an Amine Building Block for Neutralization

500 parts by weight of Lupranate®M20S, 135.5 parts by weight of MIBK, and 0.23 parts by weight of DBTL were charged into a reactor equipped with a condenser, a nitrogen gas inlet and outlet. This initial charge was heated to 30° C. Afterwards, 30.7 parts by weight of PD was being dosed into a reactor in a constant speed within 60 min with a continuous stirring. 406.4 parts by weight of MIBK was subsequently added into the reactor, parallelly cooling the reaction temperature to 30° C. At reaction temperature 30° C., 187.5 parts by weight of MEKO was slowly dosed into the reactor within 20 min. After finishing dosing MEKO, a reaction temperature was heated up to 60° C. and continued the reaction for another 30 min. Then cooling the reaction temperature to 30° C. again and begin a next step by quickly charging 94.4 parts by weight of DMAEA into the reactor. 20 min after finishing charging, set the reaction temperature to 60° C. again and continued stirring for another 30 min. A polyurethane crosslinker was obtained.

### Examples 4 to 14: Preparation of a Dispersion of Cationic Polyurethane Crosslinker Obtained from Example 1 in One Container

Preparing a dispersion of cationic polyurethane crosslinker involves two inversion stages: i). preparing an aqueous acid dispersion (I) of a self-emulsifying crosslinker, wherein the microstructure of liquid phase of said aqueous acid dispersion (I) is water-in-oil; and ii). adding water into said aqueous acid dispersion (I) to obtain an aqueous acid dispersion (II), wherein the microstructure of liquid phase of said aqueous acid dispersion (II) is oil-in-water.

In Examples 4 to 6, the cationic polyurethane crosslinker obtained from Example 1 having a solid content of 60% was put in a plastic container under a room temperature (20-25° C. at 1 atm.). A mixture of 26.84 parts by weight of water and 16.68 parts by weight of an aqueous formic acid solution (86 wt. %) was added to the container with a stirring speed of 1500 rpm to obtain water-in-oil phase having a solid content of 58% (the 1^{st} stage). Subsequently, 1723.3 parts by weight of water was added to the container with stirring to obtain oil-in-water phase having a solid content of 25% (the 2^{nd} stage). The difference between Examples 4 to 6 is the stirring speed in the 2^{nd} stage, i.e. 500, 1500 and 2500 rpm in Examples 4 to 6 respectively.

In Example 7, the cationic polyurethane crosslinker obtained from Example 1 having a solid content of 60% was put in a plastic container at 35° C. A mixture of 26.84 parts by weight of water and 16.68 parts by weight of an aqueous formic acid solution (86 wt. %) was added to the container with a stirring speed of 1500 rpm to obtain water-in-oil phase having a solid content of 58% (the 1^{st} stage). Subsequently, 1723.3 parts by weight of water was added to the container with a stirring speed of 500 rpm to obtain oil-in-water phase having a solid content of 25% (the 2^{nd} stage).

In Example 8, the cationic polyurethane crosslinker obtained from Example 1 having a solid content of 60% was put in a plastic container at 50° C. A mixture of 26.84 parts by weight of water and 16.68 parts by weight of an aqueous formic acid solution (86 wt. %) was added to the container with a stirring speed of 1500 rpm to obtain water-in-oil phase having a solid content of 58% (the 1^{st} stage). Subsequently, 1723.3 parts by weight of water was added to the container with a stirring speed of 1500 rpm to obtain oil-in-water phase having a solid content of 25% (the 2^{nd} stage).

In Example 9, the cationic polyurethane crosslinker obtained from Example 1 having a solid content of 58% was put in a plastic container under room temperature (20-25° C. at 1 atm.). A mixture of 26.84 parts by weight of water and 16.68 parts by weight of an aqueous formic acid solution (86 wt. %) was added to the container with a stirring speed of 1500 rpm to obtain water-in-oil phase (the 1^{st} stage). Subsequently, 1723.3 parts by weight of water was added to the container with a stirring speed of 1500 rpm to obtain oil-in-water phase having a solid content of 25% (the 2^{nd} stage).

In Example 10, the cationic polyurethane crosslinker obtained from Example 1 having a solid content of 49% was put in a plastic container under room temperature (20-25° C. at 1 atm.). A mixture of 266.6 parts by weight of water and 16.68 parts by weight of an aqueous formic acid solution (86 wt. %) was added to the container with a stirring speed of 1500 rpm to obtain water-in-oil phase (the 1^{st} stage). Subsequently, 1483.5 parts by weight of water was added to the container with a stirring speed of 1500 rpm to obtain oil-in-water phase having a solid content of 25% (the 2^{nd} stage).

In Example 11, the cationic polyurethane crosslinker obtained from Example 1 having a solid content of 38% was put in a plastic container under room temperature (20-25° C. at 1 atm.). A mixture of 713.9 parts by weight of water and 16.68 parts by weight of an aqueous formic acid solution (86 wt. %) was added to the container with a stirring speed of 1500 rpm to obtain water-in-oil phase (the 1^{st} stage). Subsequently, 1036.2 parts by weight of water was added to the container with a stirring speed of 1500 rpm to obtain oil-in-water phase having a solid content of 25% (the 2^{nd} stage).

In Example 12, the cationic polyurethane crosslinker obtained from Example 1 having a solid content of 58% was put in a plastic container under room temperature (20-25° C. at 1 atm.). A mixture of 24.8 parts by weight of water and 18.7 parts by weight of acetic acid was added to the container with a stirring speed of 1500 rpm to obtain water-in-oil phase (the 1^{st} stage). Subsequently, 1723.3 parts by weight of water was added to the container with a stirring speed of 1500 rpm to obtain oil-in-water phase having a solid content of 25% (the 2^{nd} stage).

In Example 13, the cationic polyurethane crosslinker obtained from Example 1 having a solid content of 49% was put in a plastic container under room temperature (20-25° C. at 1 atm.). A mixture of 264.6 parts by weight of water and 18.7 parts by weight of acetic acid was added to the container with a stirring speed of 1500 rpm to obtain water-in-oil phase (the 1^{st} stage). Subsequently, 1483.5 parts by weight of water was added to the container with a stirring speed of 1500 rpm to obtain oil-in-water phase having a solid content of 25% (the 2^{nd} stage).

In Example 14, the cationic polyurethane crosslinker obtained from Example 1 having a solid content of 38% was put in a plastic container under room temperature (20-25° C. at 1 atm.). A mixture of 711.9 parts by weight of water and 18.7 parts by weight of acetic acid was added to the container with a stirring speed of 1500 rpm to obtain water-in-oil phase (the 1^{st} stage). Subsequently, 1036.2 parts by weight of water was added to the container with a stirring speed of 1500 rpm to obtain oil-in-water phase having a solid content of 25% (the 2^{nd} stage).

### Examples 15 to 20: Preparation of a Dispersion of Cationic Polyurethane Crosslinker Obtained from Example 2 in One Container

In Example 15, the cationic polyurethane crosslinker obtained from Example 2 having a solid content of 58% was put in a plastic container under room temperature (20-25° C. at 1 atm.). A mixture of 6.8 parts by weight of water and 41.5 parts by weight of an aqueous formic acid solution (86 wt. %) was added to the container with a stirring speed of 1500 rpm to obtain water-in-oil phase (the 1^{st} stage). Subsequently, 1910.1 parts by weight of water was added to the container with a stirring speed of 1500 rpm to obtain oil-in-water phase having a solid content of 25% (the 2^{nd} stage).

In Example 16, the cationic polyurethane crosslinker obtained from Example 2 having a solid content of 49% was put in a plastic container under room temperature (20-25° C. at 1 atm.). A mixture of 272.6 parts by weight of water and 41.5 parts by weight of an aqueous formic acid solution (86 wt. %) was added to the container with a stirring speed of 1500 rpm to obtain water-in-oil phase (the 1^{st} stage). Subsequently, 1644.3 parts by weight of water was added to the container with a stirring speed of 1500 rpm to obtain oil-in-water phase having a solid content of 25% (the 2^{nd} stage).

In Example 17, the cationic polyurethane crosslinker obtained from Example 2 having a solid content of 38% was put in a plastic container under room temperature (20-25° C. at 1 atm.). A mixture of 768.4 parts by weight of water and 41.5 parts by weight of an aqueous formic acid solution (86 wt. %) was added to the container with a stirring speed of 1500 rpm to obtain water-in-oil phase (the 1^{st} stage). Subsequently, 1148.5 parts by weight of water was added to the container with a stirring speed of 1500 rpm to obtain oil-in-water phase having a solid content of 25% (the 2^{nd} stage).

In Example 18, the cationic polyurethane crosslinker obtained from Example 2 having a solid content of 58% was put in a plastic container under room temperature (20-25° C. at 1 atm.). A mixture of 1.7 parts by weight of water and 46.5 parts by weight of acetic acid was added to the container with a stirring speed of 1500 rpm to obtain water-in-oil phase (the 1^{st} stage). Subsequently, 1910.1 parts by weight of water was added to the container with a stirring speed of 1500 rpm to obtain oil-in-water phase having a solid content of 25% (the 2^{nd} stage).

In Example 19, the cationic polyurethane crosslinker obtained from Example 2 having a solid content of 49% was put in a plastic container under room temperature (20-25° C. at 1 atm.). A mixture of 267.5 parts by weight of water and 46.5 parts by weight of acetic acid was added to the container with a stirring speed of 1500 rpm to obtain water-in-oil phase (the 1^{st} stage). Subsequently, 1644.3 parts by weight of water was added to the container with a stirring speed of 1500 rpm to obtain oil-in-water phase having a solid content of 25% (the 2^{nd} stage).

In Example 20, the cationic polyurethane crosslinker obtained from Example 2 having a solid content of 38% was put in a plastic container under room temperature (20-25° C. at 1 atm.). A mixture of 763.3 parts by weight of water and 46.5 parts by weight of acetic acid was added to the container with a stirring speed of 1500 rpm to obtain water-in-oil phase (the 1^{st} stage). Subsequently, 1148.5 parts by weight of water was added to the container with a stirring speed of 1500 rpm to obtain oil-in-water phase having a solid content of 25% (the 2^{nd} stage).

### Examples 21 to 26: Preparation of a Dispersion of Cationic Polyurethane Crosslinker Obtained from Example 3 in One Container

In Example 21, the cationic polyurethane crosslinker obtained from Example 3 having a solid content of 58% was put in a plastic container under room temperature (20-25° C. at 1 atm.). A mixture of 26.0 parts by weight of water and 20.7 parts by weight of an aqueous formic acid solution (86 wt. %) was added to the container with a stirring speed of 1500 rpm to obtain water-in-oil phase (the 1^{st} stage). Subsequently, 1849.6 parts by weight of water was added to the container with a stirring speed of 1500 rpm to obtain oil-in-water phase having a solid content of 25% (the 2^{nd} stage).

In Example 22, the cationic polyurethane crosslinker obtained from Example 3 having a solid content of 49% was put in a plastic container under room temperature (20-25° C. at 1 atm.). A mixture of 283.3 parts by weight of water and 20.7 parts by weight of an aqueous formic acid solution (86 wt. %) was added to the container with a stirring speed of 1500 rpm to obtain water-in-oil phase (the 1^{st} stage). Subsequently, 1592.2 parts by weight of water was added to the container with a stirring speed of 1500 rpm to obtain oil-in-water phase having a solid content of 25% (the 2^{nd} stage).

In Example 23, the cationic polyurethane crosslinker obtained from Example 3 having a solid content of 38% was put in a plastic container under room temperature (20-25° C. at 1 atm.). A mixture of 763.5 parts by weight of water and 20.7 parts by weight of an aqueous formic acid solution (86 wt. %) was added to the container with a stirring speed of 1500 rpm to obtain water-in-oil phase (the 1^{st} stage). Subsequently, 1112.1 parts by weight of water was added to the container with a stirring speed of 1500 rpm to obtain oil-in-water phase having a solid content of 25% (the 2^{nd} stage).

In Example 24, the cationic polyurethane crosslinker obtained from Example 3 having a solid content of 58% was put in a plastic container under room temperature (20-25° C. at 1 atm.). A mixture of 23.4 parts by weight of water and 23.3 parts by weight of acetic acid was added to the container with a stirring speed of 1500 rpm to obtain water-in-oil phase (the 1^{st} stage). Subsequently, 1849.6 parts by weight of water was added to the container with a stirring speed of 1500 rpm to obtain oil-in-water phase having a solid content of 25% (the 2^{nd} stage).

In Example 25, the cationic polyurethane crosslinker obtained from Example 3 having a solid content of 49% was put in a plastic container under room temperature (20-25° C. at 1 atm.). A mixture of 280.8 parts by weight of water and 23.3 parts by weight of acetic acid was added to the container with a stirring speed of 1500 rpm to obtain water-in-oil phase (the 1^{st} stage). Subsequently, 1592.2 parts by weight of water was added to the container with a stirring speed of 1500 rpm to obtain oil-in-water phase having a solid content of 25% (the 2^{nd} stage).

In Example 26, the cationic polyurethane crosslinker obtained from Example 3 having a solid content of 38% was put in a plastic container under room temperature (20-25° C. at 1 atm.). A mixture of 760.9 parts by weight of water and 23.3 parts by weight of acetic acid was added to the container with a stirring speed of 1500 rpm to obtain water-in-oil phase (the 1^{st} stage). Subsequently, 1112.1 parts by weight of water was added to the container with a stirring speed of 1500 rpm to obtain oil-in-water phase having a solid content of 25% (the 2^{nd} stage).

### Example 27: Preparation of a Dispersion of Cationic Polyurethane Crosslinker Obtained from Example 1 by Using Two Containers

The cationic polyurethane crosslinker obtained from Example 1 was put in a plastic container (the 1^{st} container) under room temperature (20-25° C. at 1 atm.) of which the solid content is 60%. A mixture of 266.6 parts by weight of water and 16.68 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm to reach a solid content of 49% and subsequently, 1483.5 parts by weight of water was added to the 2^{nd} container with a stirring speed of 1500 rpm to reach a solid content of 25%.

### Example 28: Preparation of a Dispersion of Cationic Polyurethane Crosslinker Obtained from Example 2 by Using Two Containers

The cationic polyurethane crosslinker obtained from Example 2 was put in a plastic container (the 1^{st} container) under room temperature (20-25° C. at 1 atm.) of which the solid content is 60%. A mixture of 272.6 parts by weight of water and 41.5 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm to reach a solid content of 49% and subsequently, 1644.3 parts by weight of water was added to the 2^{nd} container with a stirring speed of 1500 rpm to reach a solid content of 25%.

### Example 29: Preparation of a Dispersion of Cationic Polyurethane Crosslinker Obtained from Example 3 by Using Two Containers

The cationic polyurethane crosslinker obtained from Example 3 was put in a plastic container (the 1^{st} container) under room temperature (20-25° C. at 1 atm.) of which the solid content is 60%. A mixture of 283.3 parts by weight of water and 20.7 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm to reach a solid content of 49% and subsequently, 1592.2 parts by weight of water was added to the 2^{nd} container with a stirring speed of 1500 rpm to reach a solid content of 25%.

### Examples 30 to 31: Preparation of a Dispersion of Cationic Polyurethane Crosslinker Obtained from Example 1 in One Step by Using Two Containers

In Example 30, the cationic polyurethane crosslinker obtained from Example 1 was put in a plastic container (the 1^{st} container) under room temperature (20-25° C. at 1 atm.) of which the solid content is 60%. A mixture of 1750.1 parts by weight of water and 16.68 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm continuously to reach a solid content of 25%.

In Example 31, the cationic polyurethane crosslinker obtained from Example 1 was put in a plastic container (the 1^{st} container) under room temperature (20-25° C. at 1 atm.) of which the solid content is 60%. A mixture of 1748.1 parts by weight of water and 18.7 parts by weight of acetic acid was prepared in another container (the 2^{nd} container). The cationic polyurethane crosslinker in the 1^{st} container was added into the 2^{nd} container with a stirring speed of 1500 rpm continuously to reach a solid content of 25%.

### Examples 32 to 33: Preparation of a Dispersion of Cationic Polyurethane Crosslinker Obtained from Example 2 in One Step by Using Two Containers

In Example 32, the cationic polyurethane crosslinker obtained from Example 2 was put in a plastic container (the 1^{st} container) under room temperature (20-25° C. at 1 atm.) of which the solid content is 60%. A mixture of 1916.8 parts by weight of water and 41.46 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm continuously to reach a solid content of 25%.

In Example 33, the cationic polyurethane crosslinker obtained from Example 2 was put in a plastic container (the 1^{st} container) under room temperature (20-25° C. at 1 atm.) of which the solid content is 60%. A mixture of 1911.8 parts by weight of water and 46.5 parts by weight of acetic acid was prepared in another container (the 2^{nd} container). The cationic polyurethane crosslinker in the 1^{st} container was added into the 2^{nd} container with a stirring speed of 1500 rpm continuously to reach a solid content of 25%.

### Examples 34 to 35: Preparation of a Dispersion of Cationic Polyurethane Crosslinker Obtained from Example 3 in One Step by Using Two Containers

In Example 34, the cationic polyurethane crosslinker obtained from Example 3 was put in a plastic container (the 1^{st} container) under room temperature (20-25° C. at 1 atm.) of which the solid content is 60%. A mixture of 1875.5 parts by weight of water and 20.7 parts by weight of an aqueous formic acid solution (86 wt. %) was prepared in another container (the 2^{nd} container). The cationic polyurethane crosslinker in the 1^{st} container was added into the 2^{nd} container with a stirring speed of 1500 rpm continuously to reach a solid content of 25%.

In Example 35, the cationic polyurethane crosslinker obtained from Example 3 was put in a plastic container (the 1^{st} container) under room temperature (20-25° C. at 1 atm.) of which the solid content is 60%. A mixture of 1873 parts by weight of water and 23.3 parts by weight of acetic acid was prepared in another container (the 2^{nd} container). The cationic polyurethane crosslinker in the 1^{st} container was added into the 2^{nd} container with a stirring speed of 1500 rpm continuously to reach a solid content of 25%.

### Performance Test

### <Tₘₐₓ>

Tₘₐₓ is the detected highest temperature of the dispersion solution during the process of adding solvent (e.g. a mixture of water and acid) with stirring. Tₘₐₓ is tested by IKA RET basic S025 including temperature sensor.

### <Z-Average Particle Size>

The Z-average particle size of the dispersion is tested according to the standard DIN ISO 13321 by using Paticle size analyzer, Malvern, Zetasizer Nano zs90 (model ZEN3690).

### <PDI>

PDI (Polydispersity Index) of the dispersion is tested according to the standard DIN ISO 13321 by using Paticle size analyzer, Malvern, Zetasizer Nano zs90 (model ZEN3690).

### <Storage Stability>

The storage stability of each dispersion was evaluated by visually observing the appearance of the dispersion in a transparent container after standing for a period of time at a certain temperature. The dispersion is evaluated as “unstable”, if a phase separation (serious) or a sedimentation (mild) occurs.

The performance test results of Examples 4 to 35 are summerized in Table 1.

TABLE 1

| | Performance Test | | | | | |
|---|---|---|---|---|---|---|
| Example | Tₘₐₓ | Z-average particle size | | PDI | Storage stability | |
| 4 | 28° C. | 121 | nm | 0.05 | 24 | hours |
| 5 | 35° C. | 99 | nm | 0.08 | 24 | hours |
| 6 | 43° C. | 734 | nm | 0.3 | <2 | hours |
| 7 | 39° C. | 143 | nm | 0.05 | 24 | hours |
| 8 | 52° C. | 1006 | nm | 0.36 | <2 | hours |
| 9 | 35° C. | 99 | nm | 0.08 | 24 | hours |
| 10 | 37° C. | 102 | nm | 0.11 | 24 | hours |
| 11 | 36° C. | 337 | nm | 0.26 | <6 | hours |
| 12 | 39° C. | 100 | nm | 0.13 | 24 | hours |
| 13 | 38° C. | 99 | nm | 0.12 | 24 | hours |
| 14 | 35° C. | 210 | nm | 0.21 | <6 | hours |
| 15 | 39° C. | 92 | nm | 0.12 | 48 | hours |
| 16 | 40° C. | 88 | nm | 0.05 | 48 | hours |
| 17 | 38° C. | 278 | nm | 0.13 | <6 | hours |
| 18 | 39° C. | 72 | nm | 0.17 | 48 | hours |
| 19 | 40° C. | 78 | nm | 0.11 | 48 | hours |
| 20 | 38° C. | 298 | nm | 0.18 | <6 | hours |
| 21 | 35° C. | 98 | nm | 0.13 | 48 | hours |
| 22 | 35° C. | 94 | nm | 0.05 | 48 | hours |
| 23 | 36° C. | 298 | nm | 0.14 | <6 | hours |
| 24 | 38° C. | 101 | nm | 0.12 | 48 | hours |
| 25 | 38° C. | 86 | nm | 0.11 | 48 | hours |
| 26 | 36° C. | 365 | nm | 0.19 | <6 | hours |
| 27 | 30° C. | 130 | nm | 0.04 | 24 | hours |
| 28 | 29° C. | 91 | nm | 0.06 | 48 | hours |
| 29 | 30° C. | 132 | nm | 0.07 | 48 | hours |
| 30 | — | 487 | nm | 0.52 | <2 | hours |
| 31 | — | 511 | nm | 0.60 | <2 | hours |
| 32 | — | 1376 | nm | 0.76 | <1 | hour |
| 33 | — | 2271 | nm | 0.09 | <1 | hour |
| 34 | — | 549 | nm | 0.96 | <2 | hours |
| 35 | — | 1481 | nm | 0.39 | <1 | hour |

As learnt from Table 1, when the initial temperature of cationic polyurethane crosslinker was at room temperature, increasing stirring speed in the 2^{nd} stage of dispersion affected the Tₘₐₓ significantly. And when the initial temperature of cationic polyurethane crosslinker was higher than room temperature e.g. 35° C. or 50° C., Tₘₐₓ also increased obviously. As a conclusion, both initial temperature of cationic polyurethane crosslinker and stirring speed in the 2^{nd} stage directly influence Tₘₐₓ of the dispersion in the 2^{nd} stage. Higher initial temperature of crosslinker and higher stirring speed increased Tₘₐₓ of the dispersion. High Tₘₐₓ resulted in big particle size and broad particle size distribution e.g. when the stirring speed is 1500 rpm in the 2^{nd} stage and the initial temperature of crosslinker is 50° C.), the Z-average particle size is 1006 nm and PDI is 0.36.

When Tₘₐₓ of cationic polyurethane crosslinkers was controlled within a range of from 35° C. to 40° C., the Z-average particle size of the resultant dispersion varies dramatically, especially in the example wherein the solid content of the 1^{st} stage dispersion was at 38%.

For cationic polyurethane crosslinker obtained from Example 1 with adding an aqueous formic acid solution to reach the solid contents of 58% and 49% of 1^{st} stage dispersion respectively, the resultant Z-average particle sizes of 2^{nd} stage dispersion were 99 nm (with PDI of 0.08) and 102 nm (with PDI of 0.11) respectively. As a contrast, when the solid content of 1^{st} stage dispersion was at 38%, the resultant Z-average particle size of 2^{nd} stage dispersion was 337 nm (with PDI of 0.26). And after the aqueous formic acid solution was changed to aqueous acetic acid solution, when the solid contents of 1^{st} stage dispersion were 58%, 49% and 38% respectively, the resultant Z-average particle sizes of 2^{nd} stage dispersion were 100 nm (with PDI of 0.13), 99 nm (with PDI of 0.12) and 210 nm (with PDI of 0.21) respectively.

For cationic polyurethane crosslinker obtained from Example 2 with adding an aqueous formic acid solution to reach the solid contents of 58% and 49% of 1^{st} stage dispersion respectively, the resultant Z-average particle sizes of 2^{nd} stage dispersion were 92 nm (with PDI of 0.12) and 88 nm (with PDI of 0.05) respectively. As a contrast, when the solid content of 1^{st} stage dispersion was at 38%, the resultant Z-average particle size was 278 nm (with PDI of 0.13). And after the aqueous formic acid solution was changed to aqueous acetic acid solution, when the solid contents of 1^{st} stage dispersion were 58%, 49% and 38% respectively, the resultant Z-average particle sizes of 2^{nd} stage dispersion were 72 nm (with PDI of 0.17), 78 nm (with PDI of 0.11) and 298 nm (with PDI of 0.18) respectively.

For cationic polyurethane crosslinker obtained from Example 3 with adding an aqueous formic acid to reach the solid contents of 58% and 49% of 1^{st} stage dispersion respectively, the resultant Z-average particle size of 2^{nd} stage dispersion were 98 nm (with PDI of 0.13) and 94 nm (with PDI of 0.05) respectively. As a contrast, when the solid content of 1^{st} stage dispersion at 38%, the Z-average particle size of 2^{nd} stage dispersion was 298 nm (with PDI of 0.14). And after the aqueous formic acid solution was changed to aqueous acetic acid solution, when the solid contents of 1^{st} stage dispersion were 58%, 49% and 38% respectively, the resultant Z-average particle sizes of 2^{nd} stage dispersion were 101 nm (with PDI of 0.12), 86 nm (with PDI of 0.11) and 365 nm (with PDI of 0.19) respectively.

The solid content of 1^{st} stage dispersion was important. When the solid content of 1^{st} stage dispersion was higher than 49% (e.g. 58%), the microstructure of said dispersion was water-in-oil and the viscosity of said dispersion was quite high. As a contrast, when the solid content of 1^{st} stage dispersion was lower than 49% (e.g. 38%), the microstructure of said dispersion was oil-in-water.

The two-phase inversion of the dispersion, i.e. from water-in-oil to oil-in-water in microstructure level, brings smaller Z-average particle size and narrower particle size distribution. If there was no such phase inversion, dispersions having large particle sizes would be obtained.

Besides, when the aqueous formic acid solution was changed to the aqueous acetic acid solution, cationic polyurethane crosslinkers obtained from Examples 1 to 3 showed similar results in terms of Z-average particle sizes.

Moreover, although according to the present invention, it is advantageous to prepare the crosslinker dispersion in one container or vessel, the experiments could be also carried out in more than one container or vessel such as two containers. And the key issue is despite how many container(s) or vessel(s) are used, the two-phase inversion of the dispersion must happen.

Examples 27 to 29 described the preparation of dispersions of cationic polyurethane crosslinkers obtained from Examples 1 to 3 respectively by using two containers and two-step dispersing approach. And their test results showed that these dispersions also had small particle sizes (e.g. in a range of from 60 nm to 160 nm) with a narrow particle size distribution (e.g. less than 0.1). Tₘₐₓ observed in 2^{nd} dispersion was around 30° C. Two phase inversion was observed during dispersion process. Therefore, by using two-step dispersing approach, dispersions having smaller particle sizes and narrow particle size distribution were obtained, although two containers or vessels are needed.

As a comparison, one-step dispersion approach is carried out by using two containers or vessels. Examples 30 to 35 described the preparation of dispersions of cationic polyurethane crosslinkers obtained from Examples 1 to 3 by using two containers and one-step dispersing approach. And their test results showed that by using two vessels and one-step dispersing approach, the obtained dispersions had large particle sizes and broad particle size distributions no matter the aqueous formic acid solution or the aqueous acetic acid solution was used. The reason is in one-step dispersing approach, there was no chance for phase inversion i.e. from water-in-oil to oil-in-water, of the dispersions in microstructure level.

1. A method of dispersing a self-emulsifying crosslinker comprising at least two steps:
i) preparing an aqueous acid dispersion (I) of a self-emulsifying crosslinker, wherein the microstructure of liquid phase of said aqueous acid dispersion (I) is water-in-oil; wherein a solid content of said aqueous acid dispersion (I) in step i) is from 45% to 75% by weight, based on the total weight of said aqueous acid dispersion (I); and
ii) adding water into said aqueous acid dispersion (I) to obtain an aqueous acid dispersion (II), wherein the microstructure of liquid phase of said aqueous acid dispersion (II) is oil-in-water; wherein a detected maximum temperature (Tₘₐₓ) of said aqueous acid dispersion (II) in step ii) is no more than 40° C.

2. The method of dispersing a self-emulsifying crosslinker according to claim 1, wherein said self-emulsifying crosslinker is at least one selected from the group consisting of cationic polyaromatic urethane, cationic polyaliphatic urethane, waterborne amino resin, cationic polyester polyurethane, cationic polyester polyurea, and cationic polycarbonate polyurethane.

3. The method of dispersing a self-emulsifying crosslinker according to claim 1, wherein in step i) said aqueous acid dispersion (I) is prepared by mixing the self-emulsifying crosslinker, acid and water under stirring at a rate in a range of from 500 to 2000 rpm and in step ii) said aqueous acid dispersion (II) is prepared under stirring at a rate in a range of from 200 to 1500 rpm.

4. The method of dispersing a self-emulsifying crosslinker according to claim 1, wherein the solid content of said aqueous acid dispersion (I) in step i) is from 50% to 70% by weight, based on the total weight of said aqueous acid dispersion (I).

5. The method of dispersing a self-emulsifying crosslinker according to claim 1, wherein the solid content of said aqueous acid dispersion (II) in step ii) is in a range of from 20% to 30% by weight, based on the total weight of said aqueous acid dispersion (II).

6. The method of dispersing a self-emulsifying crosslinker according to claim 1, wherein the detected maximum temperature (Tₘₐₓ) of said aqueous acid dispersion (II) in step ii) is no more than 30° C.

7. The method of dispersing a self-emulsifying crosslinker according to claim 1, wherein the acid used in step i) to prepare said aqueous acid dispersion (I) is at least one selected from the group consisting of diluted hydrochloric acid, diluted sulfuric acid, phosphoric acid, diluted nitric acid, boric acid, perchloric acid, formic acid, acetic acid, lactic acid, oxalic acid, glycolic acid, citric acid, malic acid, adipic acid, succinic acid, propionic acid, fumaric acid, and benzoic acid.

8. The method of dispersing a self-emulsifying crosslinker according to claim 1, wherein the weight percentage of acid in said aqueous acid dispersion (I) is in a range of from 0.1 wt. % to 5.0 wt. %.

9. A self-emulsifying crosslinker dispersion prepared by the method according to claim 1, wherein said self-emulsifying crosslinker dispersion has a Z-average particle size in a range of from 50 to 200 nm.

10. The self-emulsifying crosslinker dispersion according to claim 9, wherein said self-emulsifying crosslinker dispersion has a PDI (Polydispersity Index) of less than 0.2.

11. The self-emulsifying crosslinker dispersion according to claim 9, wherein solid content of said self-emulsifying crosslinker dispersion is in a range of from 20% to 30% by weight.

12. The self-emulsifying crosslinker dispersion according to claim 9, wherein said self-emulsifying crosslinker dispersion comprising at least one selected from the group consisting of cationic polyaromatic urethane, cationic polyaliphatic urethane, waterborne amino resin, cationic polyester polyurethane, cationic polyester polyurea, and cationic polycarbonate polyurethane.

13. An e-coat composition comprising at least one base resin dispersion and at least one self-emulsifying crosslinker dispersion according to claim 9.

14. The e-coat composition according to claim 13, wherein said base resin is at least one selected from the group consisting of polyetheramine and polyetheramine-based epoxy resin.

15. The e-coat composition according to claim 13, wherein said e-coat composition has a curing temperature in a range of from 80° C. to 140° C.

16. An e-coat layer obtained from the e-coat composition according to claim 13 after curing at a temperature in a range of from 80° C. to 140° C.

17. A substrate coated with the e-coat layer according to claim 16.

18. A self-emulsifying crosslinker dispersion prepared by the method according to claim 1, wherein said self-emulsifying crosslinker dispersion has a Z-average particle size in a range of from 60 to 160 nm.

19. The self-emulsifying crosslinker dispersion according to claim 9, wherein said self-emulsifying crosslinker dispersion has a PDI (Polydispersity Index) of less than 0.1.
